(19) United States
(12) Patent Application Publication
(10) Pub. No.: US 2025/0392243 A1
(43) Pub. Date: Dec. 25, 2025

(54) DYNAMICALLY RECONFIGURABLE MULTI MODE POWER CONVERTER UTILIZING WINDINGS OF ELECTRIC MACHINE

(71) Applicant: EXRO TECHNOLOGIES INC., Calgary (CA)

(72) Inventor: Eric Hustedt, Calgary (CA)

(21) Appl. No.: 19/247,025

(22) Filed: Jun. 24, 2025

Related U.S. Application Data
(60) Provisional application No. 63/663,531, filed on Jun. 24, 2024.

(51) Int. Cl. H02P 25/18

(52) U.S. Cl. CPC H02P 25/188

(57) ABSTRACT

A system, device, and method to convert power and drive electric machines, for instance electric motors advantageously employs an open winding inverter comprising of an H bridge per machine phase and an arrangement of switches in the DC supply to dynamically reconfigure the motor winding between two operating modes in order to deliver higher performance and efficiency of an electric machine over wide operating speed range, all while reducing silicon usage.

### CROSS REFERENCE TO RELATED APPLICATIONS

This application claims the benefit of U.S. Patent Application 63/663,531 filed Jun. 24, 2024, and entitled “Dynamically Reconfigurable Multi Mode Power Converter Utilizing Windings Of Electric Machine” the disclosure of which is incorporated herein by reference.

### TECHNICAL FIELD

The present disclosure relates generally to systems, apparatus and/or methods for power conversion and driving electric machines, for example systems, apparatus and/or methods to drive rotating electric machines such as electric motors.

### BACKGROUND

### Description of the Related Art

Electric machines take a variety of forms, for example rotating electric machines such as electric motors and electric generators, or electric machines that can operate as an electric motor during one period while operating as an electric generator during another period. These rotating electric machines are referred to as such since they typically include a rotor that rotates with respect to a stator.

An electric machine can, for example, take the form of an electric machine of an electric vehicle (e.g., plug-in fully electric vehicle or plug-in hybrid electric vehicle) that during operation of the electric vehicle acts as a traction motor and/or a regenerative braking generator to recover kinetic energy of the moving vehicle and restore that energy to the battery of the electric vehicle.

Historically n-phase electric machines are driven by n-phase inverters with the winding in a fixed configuration, where n represents the numerical number of phases in the machine, for example 3, 5, 6, 7 etc. This constrains the operating capability of the electric machine, especially when operation over a wide speed range is desired. In these systems the motor or generator winding can be configured in star/WYE or delta, with each phase terminal connected to a single half bridge.

FIG. 1 shows a system 100 including conventional 3-phase motor drive architecture implemented as a 3 phase inverter 102 employing three half bridges coupled between a DC power supply 104 and an electric machine 105 (e.g., a rotating electric machine for example operable as an electronic motor). The conventional 3-phase motor drive architecture can be generalized to n phases with n half bridges, for example a 7-phase electric machine would require 7 half bridges and so on.

FIG. 2 shows a system 200 including an alternative “open winding” architecture illustrated as a quantity of three single phase inverters 202, thus comprising six half bridges as a 3×H-bridge inverter coupled between a DC power supply 204 and an electric machine 205 (e.g., a rotating electric machine for example operable as an electronic motor). Each motor phase coil is connected to a single-phase H bridge inverter.

FIG. 3 illustrates a system 300 employing the open winding architecture alternatively and equivalently represented as two 3-phase inverter bridges 302 operating on each side of the coils of an electric machine 305 (e.g., a rotating electric machine for example operable as an electronic motor), and electrically coupled to a DC power supply 304.

A challenge with fixed winding poly phase electric drive systems operating over wide operating speeds, for example constant power speed ratio (CPSR)>2, is reaching both low speed torque requirements and high-speed power efficiently. This is primarily due to the tradeoff between field weakening losses if the turns of the coils are increased to produce torque, or low-speed motor core losses and large inverter currents if the turns of the coils are reduced to operate efficiently at high speed.

Reconfiguring the winding on a motor dynamically to select a winding configuration appropriate for the current operating point can significantly improve system performance and efficiency.

Applicant's Prior Filings on the earlier system architectures (e.g., U.S. Pat. No. 9,812,981—which is an open winding motor drive that can switch the windings between a series and a parallel configuration, providing efficient low-speed and high-speed operation respectively—demonstrated the ability of the open winding configuration to provide low silicon use for reconfiguring motor windings due to the lower inverter currents for a given kVA (see e.g., FIG. 3 thereof). U.S. Patent Pub. No. 20230011977 discloses, inter alia, how this architecture can be adapted to operate as a general-purpose power converter for charging internal batteries from a power supply or providing power to external loads, either AC or DC (see e.g., FIG. 4A thereof).

### SUMMARY

Described herein are systems that includes a converter (i.e., circuitry) that can be selectively constructed as an open winding coil driver or as a general poly phase system.

The present disclosure eliminates the need for dedicated AC switches in the windings and utilizes the second leg of an open winding H-bridge based inverter of at least two coils to provide this functionality.

In one embodiment, this is achieved by placing switches in the positive and negative DC supply allowing the DC bus to be disconnected from the appropriate half bridge sections and then turning all the switches in those half bridges on, thereby connecting the coil ends together. In the case of the open winding architecture this action results in the series coil connection.

In such an embodiment, this advantageously places the additional silicon, that by its action will spend some significant time in the OFF state, in the DC current path. In this location, the RMS current requirements are lower since DC current is proportional to half the power delivered by the system rather than the torque required by the system, reducing the amount of silicon needed to fulfill this duty.

In addition, the ability to selectively configure the DC link connections provides both a buck and a boost mode providing bidirectional AC/DC power conversion capability when the electric machine is not turning. This allows the present disclosure to advantageously function as a battery charger from both AC and DC sources to provide energy to the internal DC bus, for example a battery. The capability to provide both a buck (step down) and boost (step up) function allows energy transfer to and from sources with either a higher or lower voltage (with in device limits) than the internal pack or DC link voltage. Furthermore, in addition to charging the internal DC supply, alternatively, the system can provide AC or DC power to an external load, for example as emergency backup, V2x (vehicle to grid), micro grid, site power etc. This can be advantageous for example if the vehicle or system application is powered by a fuel cell or similarly refuellable chemical energy source.

In at least one aspect, a dynamically reconfigurable power converter operable selectively as an open winding coil driver or as a poly phase system, includes a voltage bus having a first voltage rail and a second voltage rail, the voltage bus coupled or couplable between a direct current (DC) storage and a power source; a first set of switches wherein at least two pairs of switches of the first set of switches are arranged in respective half bridges between the first and the second voltage rails of the voltage bus, each of the half bridges having a respective a center node that is coupled or couplable to a first terminal of a respective coil of an electric machine; a second set of switches wherein at least two pairs of switches of the second set of switches are arranged in respective half bridges between the first and the second voltage rails of the voltage bus, each of the half bridges having a respective a center node that is coupled or couplable to a second terminal of a respective coil of the electric machine; and coupled in the first voltage rail and one or more switches of the third set of switches is electrically coupled in the second voltage rail, and the switches of the third set of switches are operable to selectively isolate the second set of switches.

The dynamically reconfigurable power converter can also include a control subsystem, the control subsystem communicatively coupled to control a state of the switches of the first set of switches, a state of the switches of the second set of switches, and a state of the switches of the third set of switches. The control subsystem communicatively coupled to control a state of the switches of the first set of switches, a state of the switches of the second set of switches, and a state of the switches of the third set of switches.

The control subsystem can, for example, control the state of the switches to operate the first set of switches as series half bridges, to operate the second set of switches either as series AC switches or parallel half bridges, and to operate the third set of switches in the open state or the closed state. For example, in a dual open winding/parallel mode, the control subsystem controls the state of the switches to operate the first set of switches and the second set of switches as open winding inverters using a respective H bridge per coil, and to place all of the switches of the third set of switches in an ON state to electrically couple the first voltage rail and the second voltage rail of the voltage bus to the switches of the second set of switches.

Also for example, in a series mode, the control subsystem controls the state of the switches to operate the switches of the first set of switches as a single-phase H bridge inverter; to place all of the switches of the second set of in an ON state completing a series connection, and place all of the switches of the third set of switches in an OFF state to disconnect the voltage bus from the switches of the second set of switches allowing the series connection to float.

As a further example, when configured for an external power transfer, the control subsystem controls the state of the switches to: in a first half cycle place one of the switches of the third set of switches in an ON state and operates the switches of the first set of switches and the switches of the second set of switches in one of an interleaved buck mode or a boost mode based on an input voltage, and in a second half cycle, place all of the switches of the first set of switches in an OFF state, place all of the switches of the second set of switches in an ON state, and place another one of the switches of the third set of switches in an ON state. When configured for an external power transfer, the control subsystem can control the state of the switches to: provide a negative connection to the voltage bus via one phase, and to concurrently provide either a step-up or a step-down DC-DC power conversion via another phase.

Where the electric machine comprises an AC motor and wherein the first set of switches is operative in a first mode as part of an inverter circuit under control of the controller subsystem, wherein in operation of the first mode, the inverter circuit converts DC power from the power storage into AC power applied to the at least one coil of the AC motor. Wherein the electric machine is a poly phasic machine comprising a pair of windings for each phase, and wherein the second set of nodes is electrically connectable to each pair of windings of each phase, and wherein in operation of a second mode, the coils of each pair can be energized in opposite polarities such that a net effect on mechanical movement of the electric machine is nullified.

In operation of a second mode, power can be transferred such that the power source supplies power to charge the power storage. Where the power source is an AC power grid, and the first set of switches can be operative, under control of the controller subsystem, to rectify AC power from the AC power grid to produce DC power. In operation of a second mode, power can be transferred such that the power storage supplies power to the power source. Wherein the power source is an AC power grid, the first set of switches can be operative, under control of the controller subsystem, to invert DC power from the power storage into AC power to be transferred to the AC power grid. In operation of a second mode, the controller subsystem can configure the switches, including the switches of the first set of switches, to implement a boost converter utilizing the at least one winding of the electric machine as a voltage-boosting inductor. Where the electric machine includes a number N of coils and the dynamically reconfigurable power converter can include an equal number of H bridge inverters, one for each respective coil, with respective half bridge legs of the H bridge inverters on each side of the third set of switches.

The converter can include a smoothing capacitor electrically coupled in parallel with the DC storage across the first voltage rail and the second voltage rail of the voltage bus between the DC storage and the first set of switches. The converter can include an energy storage capacitor electrically coupled across the first voltage rail and the second voltage rail of the voltage bus between the second set of switches and the third set of switches, wherein the energy storage capacitor averages out current for switches of the third set of switches.

A method of operating a dynamically reconfigurable power converter operable selectively as an open winding coil driver or as a poly phase system, wherein the dynamically reconfigurable power converter comprises: a voltage bus having a first voltage rail and a second voltage rail, the voltage bus coupled or couplable between a direct current (DC) storage and a power source; a first set of switches wherein at least two pairs of switches of the first set of switches are arranged in respective half bridges between the first and the second voltage rails of the voltage bus, each of the half bridges having a respective a center node that is coupled or couplable to a first terminal of a respective coil of an electric machine; a second set of switches wherein at least two pairs of switches of the second set of switches are arranged in respective half bridges between the first and the second voltage rails of the voltage bus, each of the half bridges having a respective a center node that is coupled or couplable to a second terminal of a respective coil of the electric machine; and a third set of switches wherein one or more switches of the third set of switches is electrically coupled in the first voltage rail and one or more switches of the third set of switches is electrically coupled in the second voltage rail, and the switches of the third set of switches are operable to selectively isolate the second set of switches, can include: determining an operating mode; and in response to determining that the operating mode is a dual open winding/parallel mode, controlling, by a control subsystem, a state of a plurality of switches of a first set of switches and a state of a plurality of switches of a second set of switches as open winding inverters with a respective H bridge per coil, and placing all switches of a third set of switches in an ON state to electrically couple the first voltage rail and the second voltage rail of the voltage bus to the switches of the second set of switches.

The method can include, in response to determining that the operating mode is a series mode, controlling, by the control subsystem, the state of the switches to operate the switches of the first set of switches as a single-phase H bridge inverter; to place all of the switches of the second set of in an ON state completing a series connection, and place all of the switches of the third set of switches in an OFF state to disconnect the voltage bus from the switches of the second set of switches allowing the series connection to float.

The method can include, in response to determining that the operating mode is a motor mode: determining a torque request; verifying a coil configuration, and providing motor current control via the switches. In response to determining that the coil configuration is not verified, the method can include: disabling an existing pulse width modulated drive signal; changing the state of one or more of the switches to establish a new coil configuration; and enabling a new existing pulse width modulated drive signal. The method can further include updating a set of control parameters after changing the state of one or more of the switches and before enabling a new existing pulse width modulated drive signal.

In response to determining that the operating mode is a charge mode, the method can include: determining whether a rotor of the electric machine is moving. In response to determining that the rotor of the electric machine is not moving, the method can include: determining whether input power is alternating current (AC) or direct current (DC). In response to determining that the input power is AC, the method can include: configuring the switches to rectify the AC; and operating the switches to control a charging current supplied to the power storage. In response to determining that the input power is AC, the method can further include: accessing a set of AC control parameters before configuring the switches to rectify the AC; performing AC compensation; and monitoring for an end of charging mode condition.

In response to determining that the operating mode is a charge mode, the method can include: determining whether a rotor of the electric machine is moving; in response to determining that the rotor of the electric machine is not moving: determining whether input power is alternating current (AC) or direct current (DC). In response to determining that the input power is DC the method can include: configuring the switches to condition the DC; and operating the switches to control a charging current supplied to the power storage. In response to determining that the input power is DC, the method can further include: accessing a set of DC control parameters before configuring the switches to condition the DC; and monitoring for an end of charging mode condition.

In response to determining that the operating mode is a charge mode, the method can include: determining whether a rotor of the electric machine is moving; and in response to determining that the rotor of the electric machine is moving, controlling the switches to enter a safe or stop state.

### BRIEF DESCRIPTION OF THE SEVERAL VIEWS OF DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a system implementing a conventional 3-phase motor drive architecture using three (3) half bridges.

FIG. 2 is a schematic diagram of a system implementing a conventional “open winding” architecture illustrated as three single phase inverters, thus comprising six half bridges where each motor phase coil is connected to a single-phase H bridge inverter.

FIG. 3 is a schematic diagram of a system implementing the conventional open winding architecture of FIG. 2 alternatively and equivalently drawn as two 3-phase inverter bridges operating on each side of the coils.

FIG. 4 is a schematic diagram illustrating a grid-tie arrangement according to a type of embodiment, in which one, or a group of electrical storage devices may be charged from an AC power grid, and, separately, used to supply power to the AC power grid.

FIG. 5 is a schematic diagram of a system employing a converter with charging according to at least a first illustrated implementation of embodiments of the invention.

FIG. 6 is a schematic diagram of a system employing a converter with charging according to at least a second illustrated implementation of embodiments of the invention along with a control interface.

FIG. 7 is a schematic diagram of a system employing a converter with charging according to at least a third illustrated implementation of embodiments of the invention, illustrating an N phase architecture.

FIG. 8 is a schematic diagram of a system employing a converter with charging according to at least a fourth illustrated implementation of embodiments of the invention, illustrating an N phase architecture along with a control interface.

FIGS. 9A and 9B are a flow diagram of a method of operation of a system according to one or more illustrated embodiments of the invention.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electric machines (e.g., generators, motors), control systems, and/or power conversion systems (e.g., converters, inverters, rectifiers) have not been shown or described in detail to avoid unnecessarily obscuring descriptions of the embodiments.

Unless the context requires otherwise, throughout this specification, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification, the singular forms “a,” “an,” and “the” include plural referents unless the content clearly dictates otherwise. It should also be noted that the term “or” is generally employed in its sense including “and/or” unless the content clearly dictates otherwise.

While denominated as a “power source”, in some embodiments the corresponding structure can in some instances or at some times function as a power source while in other instances or other times function as a power sink. For example, an electric grid can provide power at one time to power an electric machine or charge a power storage (e.g., secondary battery), while accepting surplus power generated by the electric machine at another time.

In many implementations, a first structure can be electrically coupled or can be electrically couplable to another structure, for instance via respective nodes or terminals. The teachings herein are equally applicable whether, for example, a converter has been electrically coupled to an electric machine, power storage and, or power source, or is otherwise configured or suited to be electrically coupled thereto when installed.

The terms coil and winding are used interchangeably herein and in the claims.

The headings and Abstract of the Disclosure provided herein are for convenience only and do not interpret the scope or meaning of the embodiments. Thus the term power source as used herein is not limited to structures solely dedicated to supplying power.

The present advantageously disclosure builds on Applicant's Prior Filings by further reducing silicon requirements and providing increased performance and system capability.

The present disclosure is also extrapolated to a general n-phase system, where n represents the quantity of phases in the system.

Coil-switching architectures utilizing AC switches to configure coils invariably have underutilized silicon since these switches will be “OFF” in one or the other winding configuration. In addition, these switches must carry motor coil or phase current, which can be substantial, resulting in large silicon consumption per switch, further compounding the issue.

The present disclosure eliminates the need for dedicated AC switches in the windings and advantageously utilizes the second leg of an open winding H-bridge based inverter of at least two coils to provide this functionality.

In one embodiment, this is achieved by placing switches in the positive and negative DC supply allowing the DC bus to be disconnected from the appropriate half bridge sections and then turning all the switches in those half bridges on, thereby connecting the coil ends together. In the case of the current generation open winding architecture this action results in the series coil connection.

In such an embodiment, this advantageously places the additional silicon, that by its action will spend some significant time in the OFF state, in the DC current path. In this location, the RMS current requirements are lower since DC current is proportional to half the power delivered by the system rather than the torque required by the system, reducing the amount of silicon needed to fulfill this duty.

In addition, the ability to selectively configure the DC link connections provides both a buck and a boost mode providing bidirectional AC/DC power conversion capability when the electric machine is not turning. This allows the present disclosure to advantageously function as a battery charger from both AC and DC sources to provide energy to the internal DC bus, for example a battery. The capability to provide both a buck (step down) and boost (step up) function allows energy transfer to and from sources with either a higher or lower voltage (with in device limits) than the internal pack or DC link voltage. Furthermore, in addition to charging the internal DC supply, alternatively, the system can provide AC or DC power to an external load, for example as emergency backup, V2x (vehicle to grid), micro grid, site power etc. This can be advantageous for example if the vehicle or system application is powered by a fuel cell or similarly refuellable chemical energy source.

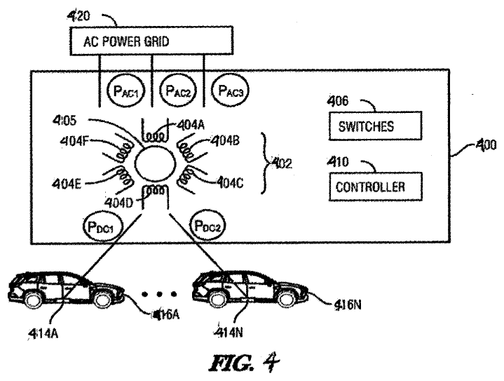

FIG. 4 is a schematic diagram illustrating a grid-tie arrangement according to a type of embodiment, in which one, or a group of electrical storage devices may be charged from an AC power grid, and, separately, used to supply power to the AC power grid. As depicted, system 400 comprises a three-phase electric machine 402 with three pairs of windings 304a, 304b, 304c, 304d, 304c, 304f, and a rotor 405. The electric machine 402 may be a traction motor of an EV, or other type of motor or generator.

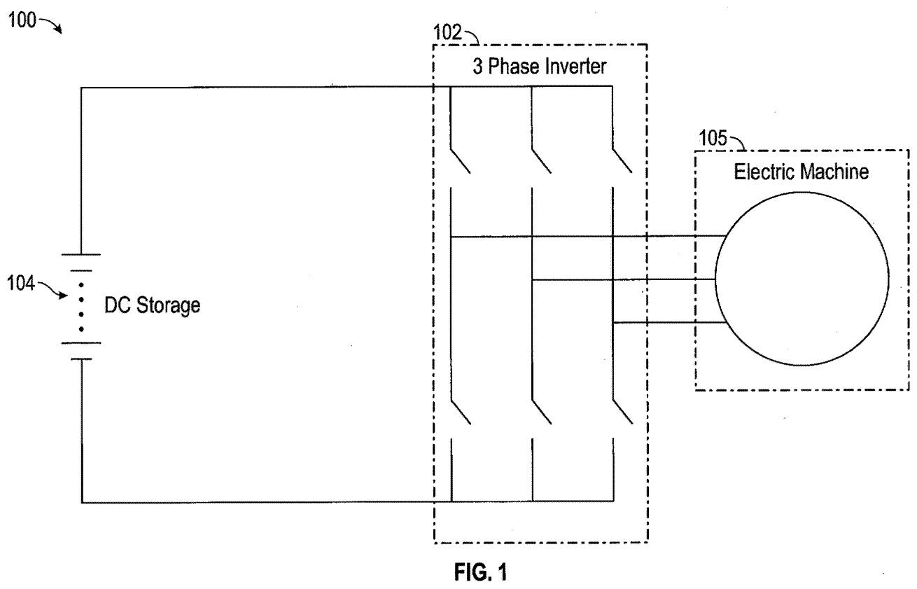

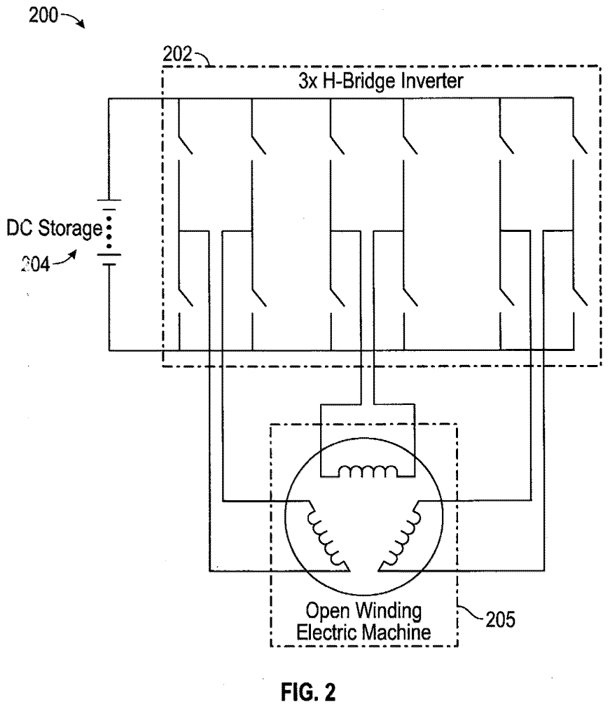

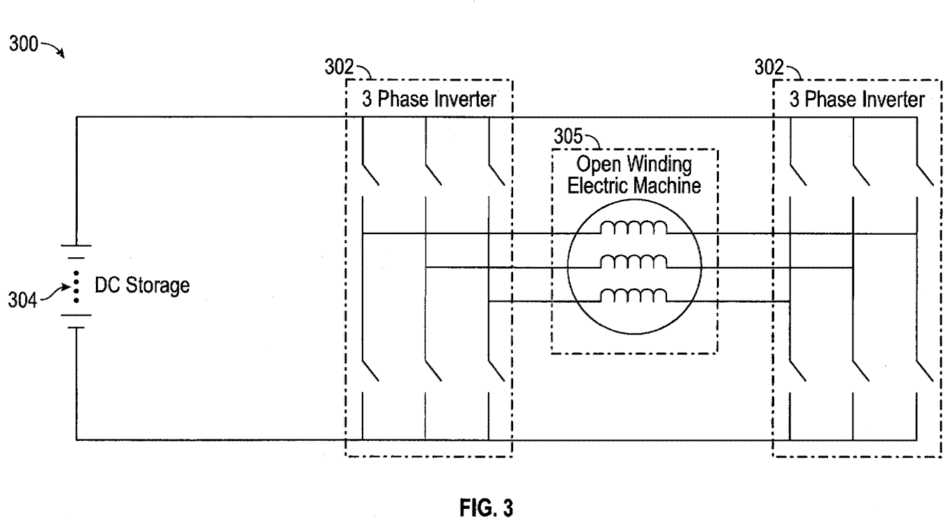

System 400 further includes switching circuitry 406 similar to switching circuitry 106 (FIG. 1), and a controller 410 that executes switching logic according to at least charging mode and supply mode. System 400 also includes a plurality of electrical probes, for example a first set of AC voltage probes P_{AC1}, P_{AC2}, P_{AC3}, and a first set of DC voltage probes P_{DC1}, P_{DC2} (only two shown) which are communicatively coupled to the controller 410 to provide signals representative of the measured voltages. While not illustrated in FIG. 4, the system 400 can employ other sensors, for examples sensors to positioned or coupled to sense the operational aspects (e.g., rotational speed, rotational position of the rotor, temperature) of the electric machine 402 or components thereof.

The system 400 is electrically coupled to an AC power grid 420, which may be available via a single-phase mains power tap, or a three-phase supply, as shown. The system 400 is also electrically couplable to one or more DC power storage devices, for instance, a number of traction motor secondary batteries 414a, 414n (only two shown) of one or more electric vehicles (EVs) 416a, 416n (only two shown) which may be part of a fleet of electric vehicles 416a, 416n. In other applications, the DC power storage device(s) may be a battery control system (BCS) as described, for example, in U.S. patent application Ser. No. 13/842,213 entitled “Battery Control Systems and Methods,” the disclosure of which is incorporated by reference herein.

Notably, system 400 may be incorporated in one of the EVs 416. Accordingly, system 400 may be arranged in one embodiment such that only the secondary battery 414 that is onboard a given EV is chargeable using system 400. In other embodiments, system 400 may charge a plurality of secondary batteries 414, including batteries of other EVs, using system 400 that is incorporated in one of the EVs of the group. In other embodiments, system 400 is not incorporated in one of EVs 416; instead, system 400 is a stand-alone system associated with an electric machine 402 which is not a motor of any EV 416.

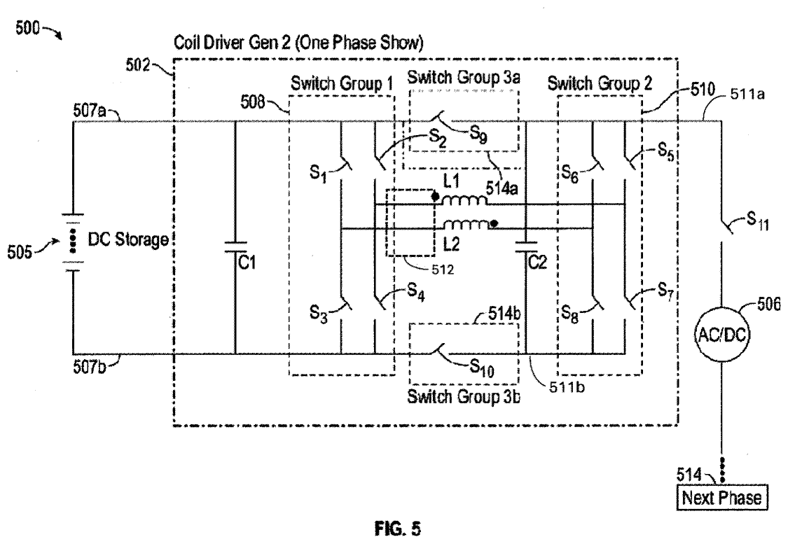

The controller 410 of the system 400 is operative to control the switches 406 to operate, at least during a first period, as a power converter according to battery charging mode to receive AC power from the AC power grid 420 and to output DC power of an appropriate voltage for the DC power storage devices (e.g., traction motor secondary batteries 414a, 414n) using the novel architecture illustrated in FIGS. 5-8 and the methods described herein. The controller 410 of the system 400 is operative according to supply mode to control the switches 406 to operate, at least during a second period, as a power converter to receive DC power from the DC power storage devices (e.g., traction motor secondary batteries 414a, 414n) and output AC power (single or three-phase) to the AC power grid 420 at an appropriate voltage and in-phase with the AC power grid. In particular, the controller 410 can open and close (turn ON and OFF) various switches to couple selected windings 404a-404f of the electric machine 402 as inductors of one or more power converter architectures as generally described herein.

For most electric machine types there are numerous control methods that may be employed and most are appropriate for the disclosed switching control system, including frequency/voltage—f/V ratio control systems, 6 step inverters, pulse width modulated (PWM) inverters, Space Vector, Field Oriented Control (FOC), etc. Many of these designs have options that may play a role in determining the best way to integrate the technology given certain circumstances and desired outcomes. As an example, the FOC systems may be sensorless, or may use encoders, Hall effect sensors, or other components with feedback loops to assist in the control of the system. While the technology may be applied to many electric machine designs, in at least one implementation of the technology into a Permanent Magnet Synchronous Machine (PMSM) using a Field Oriented Control topology with a phase locked loop based in input from a set of AC voltage probes.

FIG. 5 shows a system 500 employing a converter 502 (also referred to as a dynamically reconfigurable power converter) capable of performing charging according to at least one illustrated implementation of embodiments of the invention.

The converter 502 can be electrically coupled between a direct current (DC) power storage 504 (e.g., secondary battery cells, super-or ultracapacitor cells, fuel cells driven in reverse) and a power source 506 (e.g., an electric machine operable as a generator and, or as an electric motor; photovoltaic array, grid or mains power, household power). The converter 502 is electrically coupled across a pair of voltage rails 507a, 507b of a first voltage bus (e.g., a positive voltage rail and a negative voltage rail). A smoothing capacitor Cl can also be coupled across the voltage rails 507a, 507b of a first voltage bus in electrically in parallel with the power storage 504.

The converter 502 comprises a first set of switches 508 denominated as switch group 1, a second set of switches 510 denominated as switch group 2, and a third set of switches 514a, 514b denominated as switch group 3. The first set of switches 508 (S₁, S₂, S₃, S₄) are arranged on a first side of coils L1, L2 comprising one phase of an electric machine 512 (Don't see 512 reference in drawing?, note: added box in drawing for reference), electrically coupled across the voltage rails 507a, 507b of the first voltage bus. The second set of switches 510 (S₅, S₆, S₇, S₈) are arranged on a second side of coils L1, L2 of the electric machine 512, electrically coupled across the voltage rails 511a, 511b of a second voltage bus. The first set of switches 508 and the second set of switches 510 are selectively operable to electrically couple respective ends or terminals of the coils L1, L2 to or from the voltage rails 507a, 507b of the first voltage bus. The third set of switches (S₉, S₁₀) are arranged to selectively electrically couple and decouple the voltage rails 511a, 511b comprising the second voltage bus of set of switches 510 (switch group 2) to and from the voltage rails 507a, 507b of the first voltage bus. Thus, the respective switches S₉, S₁₀ of the third set of switches 514a, 514b are arranged along respective voltage rails 507a, 507b and 511a, 511b, between the first set of switches 508 (S₁, S₂, S₃, S₄) and second set of switches 510 (S₅, S₆, S₇, S₈). The third set of switches (S₉, S₁₀) are operable to electrically couple and decouple (i.e., electrically isolate) the second set of switches 510 from the DC storage 505 when so required and to electrically couple and decouple (i.e., electrically isolate) the external power supply 506 during charging. While each switch is generally illustrated as a single switch, it will be understood that two or more switches electrically in parallel with one another can be employed for each illustrated switch, for example to handle expected power loads. An energy storage capacitor C2 can also be electrically coupled across the voltage rails 511a, 511b of a second voltage bus (on the other side of S9 and S10 from the first voltage bus 507a, 507b) to temporarily store power. Optionally, the system 500 includes an external source switch S₁₁ operable to electrically couple and uncouple the external power source 506 from voltage rails 511a, 511b of the second voltage bus.

As illustrated, the converter 502 for one phase can be electrically coupled to a corresponding identical converter for a next phase 514.

Operation of the converter 502 is now described immediately below in which switch group 1 is the series half bridges, switch group 2 are the parallel half bridges, and switch group 3 is the DC bus switch.

In series mode: Switch group 1 operates as a single-phase H bridge inverter; Switch group 2 all switches “ON” completing series connection; Switch group 3 all switches “OFF”, disconnecting DC bus from switch group 2 since series connection must float. An energy storage capacitor C2 is discharged.

In a dual open winding/parallel mode: Switch group 1 and switch group 2 operate as open winding inverters using h bridge per coil; and Switch group 3 all switches ON connecting DC bus to switch group 2. Filtering by the energy storage capacitor C2 averages out current for switch group 3 advantageously reducing current requirements.

The structure and operation provides various benefits over those described in Applicant's Prior Filings (“conventional”). For example, the new structure and operation described herein advantageously reduce silicon content (e.g., the total silicon area required to fulfill operation). Also for example, the new structure and operation described herein advantageously allows both buck and boost mode for charging, facilitating charging of batteries with both lower and higher voltage than the connected grid power supply 506.

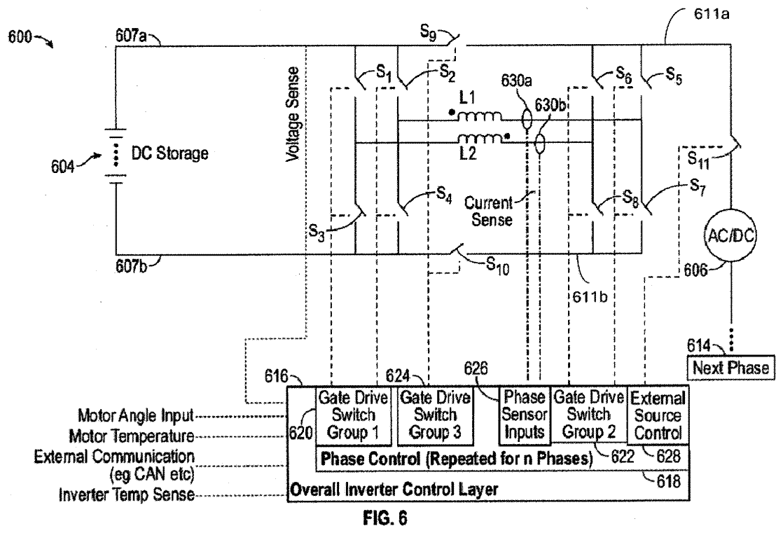

FIG. 6 shows a system 600 employing a converter 602 (also referred to as a dynamically reconfigurable power converter) capable of performing charging according to at least one illustrated implementation of embodiments of the invention. The system 600 is similar in many respects to the system 500 (FIG. 5), although FIG. 6 also illustrates a control subsystem 616 and sensors 630a, 630b are also illustrated.

The control subsystem 616 and sensors 630a, 630b is communicatively coupled to receive information or data from the sensors 630a, 630b and to control the switches as described herein.

The converter 602 can be electrically coupled between a direct current (DC) power storage 604 (e.g., secondary battery cells, super-or ultracapacitor cells, fuel cells driven in reverse) and a power source 606 (e.g., an electric machine operable as a generator, photovoltaic array, grid or mains power, household power). The converter 602 is electrically coupled across a pair of voltage rails 607a, 607b of a first voltage bus (e.g., a positive voltage rail and a negative voltage rail). A smoothing capacitor C1 can also be coupled across the voltage rails 607a, 607b of a first voltage bus in electrically in parallel with the power storage 604.

The converter 602 comprises a first set of switches S₁, S₂, S₃, S₄ denominated as switch group 1, a second set of switches S₅, S₆, S₇, S₈ denominated as switch group 2, and a third set of switches S₉, S₁₀ denominated as switch group 3. The first set of switches S₁, S₂, S₃, S₄ are arranged on a first side of coils L1, L2 comprising one phase of an electric machine, electrically coupled across the voltage rails 607a, 607b of the first voltage bus. The second set of switches S₅, S₆, S₇, S₈ are arranged on a second side of coils L1, L2 of the electric machine, electrically coupled across the voltage rails 611a, 611b of a second voltage bus. The first set of switches S₁, S₂, S₃, S₄ and the second set of switches S₅, S₆, S₇, S₈ are selectively operable to electrically couple respective ends or terminals of the coils L1, L2 to or from the voltage rails 607a, 607b of the first voltage bus and the second voltage rails 611a, 611b of the second voltage bus. The third set of switches S₉, S₁₀ are arranged to selectively electrically couple and decouple the second voltage rails 611a, 611b from the first voltage bus 607a, 607b. Thus, the respective switches S₉, S₁₀ of the third set of switches S₉, S₁₀ are arranged between respective voltage rails 607a, 607b of the first voltage bus and voltage rails 611a, 611b of the second voltage bus, between the first set of switches S₁, S₂, S₃, S₄ and second set of switches S₅, S₆, S₇, S₈. While each switch is generally illustrated as a single switch, it will be understood that two or more switches electrically in parallel with one another can be employed for each illustrated switch, for example to handle expected power loads. An energy storage capacitor C2 can also be electrically coupled across the voltage rails 611a, 611b of a second voltage bus to temporarily store power. Optionally, the system 600 includes an external source switch S₁₁ operable to electrically couple and uncouple the external power source 606 from the voltage bus.

As illustrated, the converter 602 for one phase can be electrically coupled to a corresponding converter for a next phase 614.

The control subsystem 616 (denominated as overall inverter control layer in FIG. 6) can be implemented via one or more processors (e.g., microprocessors, micro-controllers, central processing units (CPUs), graphics processing units (GPUs), digital signal processing units (DSPs), application specific integrated circuits (ASICs) and, or field programmable gate arrays (FPGSs)), with or without nontransitory processor-readable storage (e.g., read only memory (ROM), random access memory (RAM), solid state memory, FLASH memory, registers, and other volatile and, or non-volatile memory) which can store processor-executable logic or instructions to control operation of the system 600. The control subsystem 616 can implement phase control 618. The control subsystem 616 can implement a first gate drive switch group 620, a second gate drive switch group 622, and a third gate drive switch group 624, operable to provide control signals (e.g., pulse width modulated control signals) to switch the states (ON/OFF; OPEN/CLOSED) of the corresponding switches S₁, S₂, S₃, S₄; S₅, S₆, S₇, S₈; S₉, S₁₀. The control subsystem 616 monitors phase sensor inputs 626 received via phase sensor 630a, 630b which are operable to sense a respective phase of each of the coils L1, L2. The control subsystem 616 also implements an external source control 628 operable to switch the states (ON/OFF; OPEN/CLOSED) of a corresponding external source switches S₁₁.

Operation of the converter 602 is now described immediately below in which switch group 1 is the series half bridges, switch group 2 are the parallel half bridges, and switch group 3 is the series AC switch.

When the converter 602 is configured as a motor drive in “series mode”, switch group 1 (i.e., S₁, S₂, S₃, S₄) acts as an H bridge single phase inverter. Switch group 2 (i.e., S₅, S₆, S₇, S₈) has all switches turned “ON” connecting the positive end of coil L2 and negative end of coil L1 together placing coil L1 and coil L2 in series. Energy storage element C2 is discharged. Switch group 3 (i.e., S₉, S₁₀) has all switches turned “OFF” to allow the center point of coil L1 and coil L2 to float as needed.

For “parallel mode”, both switch group 1 (i.e., S₁, S₂, S₃, S₄) and switch group 2 (i.e., S₅, S₆, S₇, S₈) function as H bridge inverters for their respective coils and switch group 3 (i.e., S₉, S₁₀) is turned “ON” to connect the DC link to switch group 2. Energy storage element C2 provides current averaging for switch group 3 (i.e., S₉, S₁₀).

When the converter 602 is configured for external power transfer, for example charging on a positive half AC cycle, switch group 3b (i.e., S₁₀) is “ON” and switch groups 1 (i.e., S₁, S₂, S₃, S₄) and switch group 22 (i.e., S₅, S₆, S₇, S₈) act either in interleaved buck or boost mode depending on the input voltage. Then for the negative half of the cycle all switches in switch group 1 (i.e., S₁, S₂, S₃, S₄) are “OFF”, all switches in switch group 2 (i.e., S₅, S₆, S₇, S₈) are “ON”, switch group 3b (i.e., S₁₀) is also “ON”. This connects the power source 606 (e.g., AC grid line) for this phase to the DC link negative terminal, and the aforementioned PWM action is carried out by an adjacent phase. Similar action can operate with DC input (or output), in this case one phase is simply providing the negative connection to the DC link, while (i.e., concurrently) another phase provides either step-up or step-down DC-DC power conversion. N−1 “channels” of power conversion can be achieved, where N is the number of phases in the system, for example a 3-phase embodiment of the present disclosure can provide two channels of buck and/or boost DC-DC power conversion for example to allow direct PV solar charging via a Maximum Power Point Tracking (MPPT) algorithm.

Adding more H bridge inverters and a respective coils to the converter 602, with respective half bridge legs on each side of switch group 3, creates a poly phase inverter system capable of configuring a n-phase machine between star and open-winding operation.

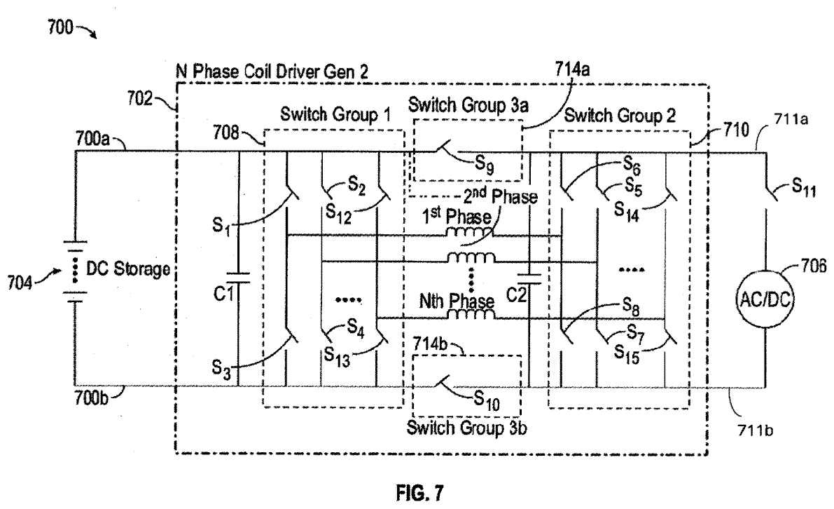

FIG. 7 shows a system 700 employing a converter 702 (also referred to as a dynamically reconfigurable power converter) capable of performing charging according to at least one illustrated implementation of embodiments of the invention. The system 700 is similar in many respects to the system 500 (FIG. 5) and the system 600 (FIG. 6), however generalizes such to more than one phase (e.g., N phases).

The converter 702 can be electrically coupled between a direct current (DC) power storage 704 (e.g., secondary battery cells, super- or ultracapacitor cells, fuel cells driven in reverse) and a power source 706 (e.g., an electric machine operable as a generator, photovoltaic array, grid or mains power, household power). The converter 702 is electrically coupled across a pair of voltage rails 707a, 707b of a first voltage bus (e.g., a positive voltage rail and a negative voltage rail). A smoothing capacitor Cl can also be coupled across the voltage rails 707a, 707b of a first voltage bus in electrically in parallel with the power storage 704.

The converter 702 comprises a first set of switches 708 denominated as switch group 1, a second set of switches 710 denominated as switch group 2, and a third set of switches 714a, 714b denominated as switch group 3. The first set of switches 708 (S₁, S₂, S₃, S₄, S₁₂, S₁₃) are arranged on a first side of coils L1, L2, Ln of an electric machine 712, where n denotes the number of phases, electrically coupled across the voltage rails 707a, 707b of the first voltage bus. The second set of switches 710 (S₅, S₆, S₇, S₈, S₁₄, S₁₅) are arranged on a second side of coils L1, L2, Ln of the electric machine 712, electrically coupled across the voltage rails 711a, 711b of a second voltage bus. The first set of switches 708 and the second set of switches 710 are selectively operable to electrically couple respective ends or terminals of the coils L1, L2, LN to or from the voltage rails 707a, 707b of the voltage bus and voltage rails 711a, 711b of the second voltage bus. The third set of switches (S₉, S₁₀) are arranged to selectively electrically couple and decouple the voltage rails 707a, 707b of the first voltage bus from voltage rails 711a, 711b of the second voltage bus. Thus, the respective switches S₉, S₁₀ of the third set of switches 714a, 714b are arranged along respective voltage rails 707a, 707b of a first voltage bus, and rails 711a, 711b of a second voltage bus, between the first set of switches 708 (S₁, S₂, S₃, S₄, S₁₂, S₁₃) and second set of switches 710 (S₅, S₆, S₇, S₈, S₁₄, S₁₅). While each switch is generally illustrated as a single switch, it will be understood that two or more switches electrically in parallel with one another can be employed for each illustrated switch, for example to handle expected power loads. An energy storage capacitor C2 can also be electrically coupled across the voltage rails 707a, 707b of a first voltage bus to temporarily store power. Optionally, the system 700 includes an external source switch Su operable to electrically couple and uncouple the power source 706 from the voltage bus.

Operation of the converter 702 is now described immediately.

In a “Star” mode: Switch group 1 operates as an inverter; Switch group 2 all switches “ON” completing a neutral circuit; Switch group 3 all switches “OFF”, disconnecting the DC bus from switch group 2 since the neutral point must float. The energy storage capacitor C2 is discharged.

In an open winding/“Delta” mode: Switch group 1 and switch group 2 operate as open winding inverters using H bridge per coil; and Switch group 3 all switches ON connecting DC bus to switch group 2. Filtering by the energy storage capacitor C2 advantageously averages out current for switch group 3 reducing current requirements.

The structure and operation provides various benefits over those described in Applicant's Prior Filings (“conventional”). For example, the new structure and operation described herein advantageously provides a simplified structure with 2n motor connections versus 4n motor connections. For example, the new structure and operation described herein advantageously n current sensors instead of 2n current sensors, where n denotes the number of phases. Also for example, for three phase systems the new structure and operation described herein advantageously reduce silicon content and reduced control elements (e.g., current sensors, gate drivers etc.). Also for example, the new structure and operation described herein advantageously can be built using conventional three phase modules. As yet a further for example, the new structure and operation described herein advantageously provides for simpler winding connections as compared to previous approaches. Such can potentially provide a lower cost alternative when charging is not required. Such also can advantageously complement a coil driver system in multi-motor/drive systems, enabling charging in one, non-charging in the other.

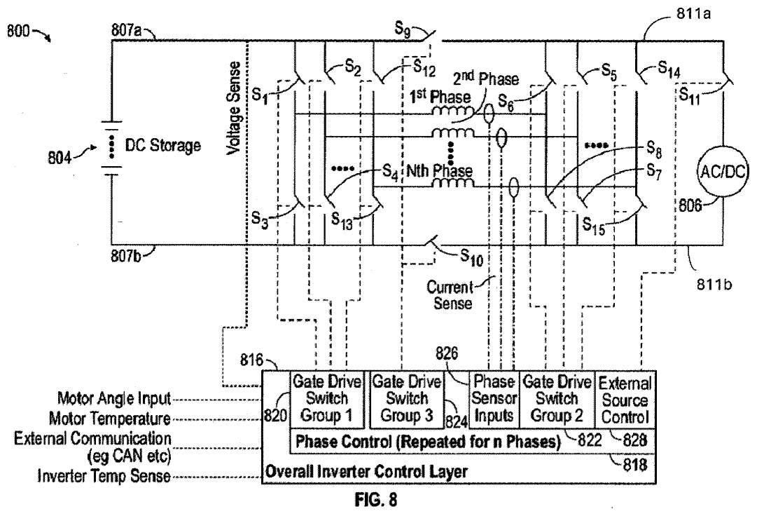

FIG. 8 shows a system 800 employing a converter 802 (also referred to as coil driver or dynamically reconfigurable power converter) capable of performing charging according to at least one illustrated implementation of embodiments of the invention. The system 800 is similar in many respects to the system 600 (FIG. 6), although FIG. 8 also illustrates a control subsystem 816 and sensors 830a, 830b are also illustrated.

The converter 802 can be electrically coupled between a direct current (DC) power storage 804 (e.g., secondary battery cells, super- or ultracapacitor cells, fuel cells driven in reverse) and a power source 806 (e.g., an electric machine operable as a generator, photovoltaic array, grid or mains power, household power). The converter 802 is electrically coupled across a pair of voltage rails 807a, 807b of a first voltage bus (e.g., a positive voltage rail and a negative voltage rail) and a further pair of voltage rails 811a, 811b of a second voltage bus.

The converter 802 comprises a first set of switches S₁, S₂, S₃, S₄, S₁₂, S₁₃ (referred to as switch group 1), a second set of switches S₅, S₆, S₇, S₈, S₁₄, S₁₅ (referred to as switch group 2), and a third set of switches S₉, S₁₀ (referred to as switch group 3). The first set of switches S₁, S₂, S₃, S₄, S₁₂, S₁₃ are arranged on a first side of coils L1, L2, LN of an electric machine, electrically coupled across the voltage rails 807a, 807b of the voltage bus. The second set of switches S₅, S₆, S₇, S₈, S₁₄, S₁₅ are arranged on a second side of coils L1, L2, LN of the electric machine, where N denotes the number of phases, electrically coupled across the voltage rails 811a, 811b of a second voltage bus. The first set of switches S₁, S₂, S₃, S₄, S₁₂, S₁₃ and the second set of switches S₅, S₆, S₇, S₈, S₁₄, S₁₅ are selectively operable to electrically couple respective ends or terminals of the coils L1, L2 to or from the voltage rails 807a, 807b and 811a, 811b of the voltage buses. The third set of switches S₉, S₁₀ are arranged to selectively electrically couple and decouple the voltage rails 807a, 807b of the first voltage bus from the voltage rails 811a, 811b of the second voltage bus. Thus, the respective switches S₉, S₁₀ of the third set of switches S₉, S₁₀ are arranged along respective voltage rails 807a, 807b and 811a, 811b of the voltage buses, between the first set of switches S₁, S₂, S₃, S₄, S₁₂, S₁₃ and second set of switches S₅, S₆, S₇, S₈, S₁₄, S₁₅. While each switch is generally illustrated as a single switch, it will be understood that two or more switches electrically in parallel with one another can be employed for each illustrated switch, for example to handle expected power loads. An energy storage capacitor C2 can also be electrically coupled across the voltage rails 807a, 807b of a voltage bus to temporarily store power. Optionally, the system 800 includes an external source switch S₁₁ operable to electrically couple and uncouple the power source 806 from the voltage bus.

The control subsystem 816 (denominated as overall inverter control layer in FIG. 8) can be implemented via one or more processors (e.g., microprocessors, micro-controllers, central processing units (CPUs), graphics processing units (GPUs), digital signal processing units (DSPs), application specific integrated circuits (ASICs) and, or field programmable gate arrays (FPGSs)), with or without nontransitory processor-readable storage (e.g., read only memory (ROM), random access memory (RAM), solid state memory, FLASH memory, registers, and other volatile and, or non-volatile memory) which can store processor-executable logic or instructions to control operation of the system 800. The control subsystem 816 ca implement phase control 818. The control subsystem 816 can implement a first gate drive switch group 820, a second gate drive switch group 822, and a third gate drive switch group 824, operable to provide control signals (e.g., pulse width modulated control signals) to switch the states (ON/OFF; OPEN/CLOSED) of the corresponding switches S₁, S₂, S₃, S₄, S₁₂, S₁₃; S₅, S₆, S₇, S₈, S₁₄, S₁₅; S₉, S₁₀. The control subsystem 816 monitors phase sensor inputs 826 received via phase sensor 830a, 830b which are operable to sense a respective phase of each of the coils L1, L2, LN. The control subsystem 816 also implements an external source control 828 operable to switch the states (ON/OFF; OPEN/CLOSED) of a corresponding external source switches S₁₁.

Operation of the converter 802 is now described immediately below.

When in WYE configuration switch group 3 (S₉, S₁₀) is “OFF”, all switches in switch group 2 (S₅, S₆, S₇, S₈, S₁₄, S₁₅) are “ON”, energy storage element C2 is discharged and switch group 1 (S₁, S₂, S₃, S₄, S₁₂, S₁₃) is acting as an n phase inverter.

Open winding mode is achieved by turning switch group 3 (S₉, S₁₀) “ON” connecting DC link to switch group 2 (S₅, S₆, S₇, S₈, S₁₄, S₁₅), energy storage element C2 provides current averaging for switch group 3 (S₉, S₁₀). Both switch group 1 (S₁, S₂, S₃, S₄, S₁₂, S₁₃) and switch group 2 (S₅, S₆, S₇, S₈, S₁₄, S₁₅) are then operated as quantity N single phase H bridge inverters.

In charging mode, for example from single phase AC, during the positive half cycle, when AC voltage is greater than the DC voltage: Switch 3b (S₁₀) is ON, switch 3a (S₉) is OFF, switch group 1 has all high side devices ON, switch group 3 (S₉, S₁₀) is acting as a buck converter using the motor windings. Subsequently when the AC voltage is lower than the DC voltage, switch 3b (S₁₀) is still ON, switch 3a (S₉) is OFF, switch group 1 is now acting as a boost converter with the motor winding, switch group 2 (S₅, S₆, S₇, S₈, S₁₄, S₁₅) has all high side devices ON. For the negative cycle of the AC voltage, switch 3b (S₁₀) is OFF, switch 3a (S₁₀) is ON, and switch group 1 (S₁, S₂, S₃, S₄, S₁₂, S₁₃) and switch group 2 (S₅, S₆, S₇, S₈, S₁₄, S₁₅) function as either buck or boost as needed.

In certain embodiments, a special case exists where there is a phase number that is divisible by 3, for example 6-phase, or 9-phase. These can be considered groupings of 3-phase machines. In such embodiments, each 3-phase block can have independent switch group 3, providing similar multiphase charging capabilities as the open winding implementation of the present disclosure.

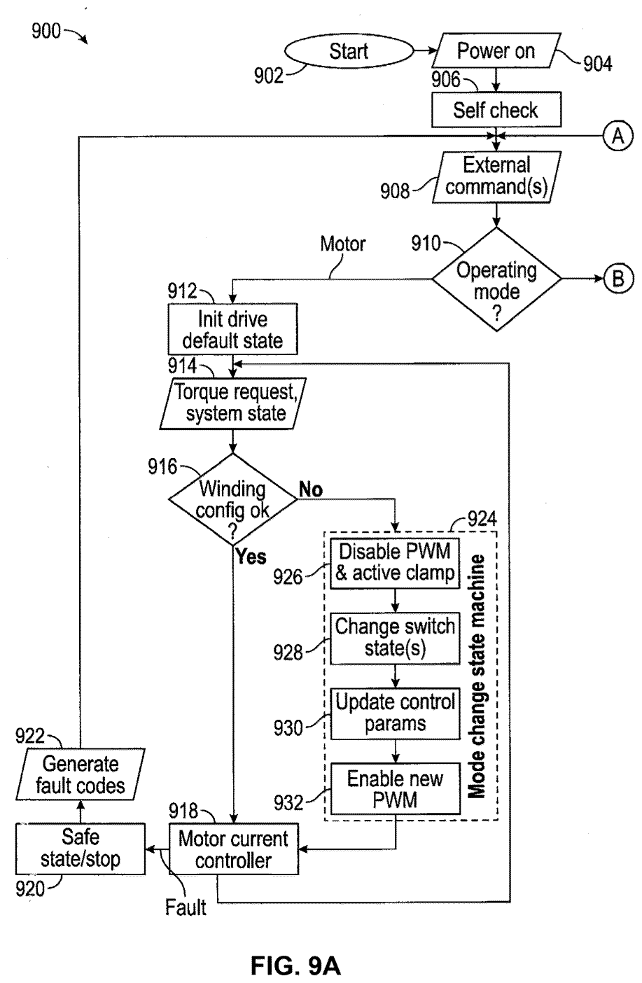

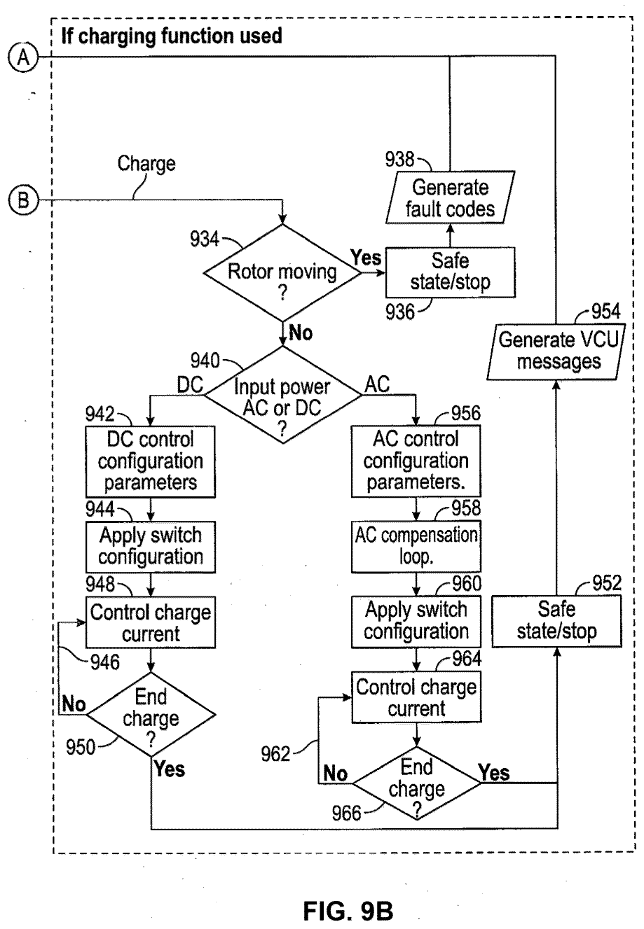

FIGS. 9A and 9B show a method 900, according to at least one illustrated implementation. The method 900 can be employed in operating the converter 502 (FIG. 5), converter 602 (FIG. 6), converter 702 (FIG. 7) and, or converter 802 (FIG. 8).

The method 900 starts at 902, for example in response to a powering ON of a system or vehicle, in response to a command or other invocation.

At 904, the method 900 monitors for a power ON event for a system, for instance a converter (also referred to as coil driver). In response, a self check routine can be executed at 906, for example determining that the circuitry and sensors are in proper operational order or condition.

At 908, the method 900 monitors for or receives external commands (e.g., commands from a throttle, commands from a motor). In response to receipt of an external command, the method can determine an operating mode at 910 (e.g., a desired operating mode).

If a charging function is not used, the operating mode may be a motor operating mode. If a charging function is used, the operating mode may be a charging operating mode.

In the motor operating mode, the method 900 at 912 initiates a drive default state for the converter. At 914, the method 900 monitors or receives a torque request and, or a system state. At 916, the method 900 determines or verifies whether a current coil or winding configuration is acceptable. If current winding configuration is acceptable, the converter operates as a motor current controller at 918. The method 900 can monitor for fault conditions. If not fault condition is detected, control can return to 914. If a fault condition is detected, the method 900 causes the converter to enter a safe state and, or a stop state at 920, and optionally generates one or more fault codes at 922. Control can then return to 908. If current winding configuration is not acceptable, the converter operates as a mode change state machine at 924.

The mode change state machine 924 can include disable PWM and active clamp at 926. At 928, change switch state(s). At 930, update control parameters. At 932, enable new drive PWM.

In the charging operating mode, the method 900 determines if a rotor is moving at 934. If the rotor is moving, the method causes the converter to enter a safe state and, or a stop state at 936, and optionally generates one or more fault codes at 938. Control can then return to 908, or optionally 906.

If at 934 it is determined that the rotor is not moving, control passes to 940 where the method 900 determines whether the input power is alternating current (AC) or direct current (DC).

If the input power is DC, the converter employs DC control configuration parameters at 942. The method 900 applies a switch configuration at 944. The method 900 then executes a charging loop 946, controlling charge current at 948 and determining whether an end of charging condition has occurred at 950. The charging loop 946 can repeat until an end of charging condition has occurs, at which point control can pass to 952 where the method 900 causes the converter to enter a safe state and, or a stop state at 952. Vehicle control unit (VCU) messages can be generated at 954.

If the input power is AC, the converter employs AC control configuration parameters at 956. The method 900 executes an AC compensation loop at 958. The method 900 applies a switch configuration at 960 to establish a desired or specified coil configuration. The method 900 then executes a charging loop 962, controlling charge current at 964 and determining whether an end of charging condition has occurred at 966. The charging loop 962 can repeat until an end of charging condition has occurs, at which point control can pass to 952 where the method 900 causes the converter to enter a safe state and, or a stop state at 952. Generate VCU messages at 954.

The various embodiments described above can be combined to provide further embodiments. Further, aspects of the above-described embodiments can be modified, if necessary, to employ systems, circuits and concepts of the various patents, applications and publications to provide yet further embodiments. For example, in any of the various embodiments, the third set of switches are operable to selectively isolate the second voltage bus from the first voltage bus.

Various implementations of coil switching motor drive systems and operation of the same are disclosed in the following U.S. patents and patent applications: U.S. patent application Ser. No. 14/295,069, granted as U.S. Pat. No. 9,812,981; U.S. patent application Ser. No. 17/605,354, granted as U.S. Pat. No. 11,722,026; U.S. patent application Ser. No. 17/742,727, granted as U.S. Pat. No. 11,967,913; U.S. patent application Ser. No. 18/066,473, granted as U.S. Pat. No. 11,785,715; U.S. patent application Ser. No. 17/860,798, published as U.S. Patent Publication US 2023/0011977; U.S. patent application Ser. No. 18/229,130, published as U.S. Patent Publication US 2025/0047194; International Patent application PCT/CA2023/051573, published as International Patent Publication WO 2024/113043 (collectively the “Prior Filings”); and U.S. Patent Application 63/663,531 filed Jun. 24, 2024, each incorporated by reference herein in their entirety.

Any incorporation by reference of documents above is limited such that no subject matter is incorporated that is contrary to the explicit disclosure herein. The claims of any of the documents are incorporated as part of the disclosure herein, unless specifically excluded.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs or logic running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure. Any incorporation by reference of documents above is limited such that no subject matter is incorporated that is contrary to the explicit disclosure herein. The claims of any of the documents are incorporated as part of the disclosure herein, unless specifically excluded.

Each of switches S₁-S₁₅ is a suitable semiconductor type switch (which may include one or multiple semiconductor devices), such as a triode for alternating current (Triac), insulated gate bipolar transistor (IGBT), field effect transistor (FET), solid state relay (SSR), or other suitable technology, which is sufficiently robust to support the voltages and currents of the application, and withstand transient spikes. Larger power-transistor-based switches may include supporting electronics, such as gate driving circuitry, snubbing circuitry, or the like, which are not shown for the sake of clarity.

The above described method(s), process(es), or technique(s) may include various acts, though those of skill in the art will appreciate that in alternative examples certain acts may be omitted and/or additional acts may be added. Those of skill in the art will appreciate that the illustrated order of the acts is shown for exemplary purposes only and may change in alternative examples. Some of the exemplary acts or operations of the above described method(s), process(es), or technique(s) are performed iteratively. Some acts of the above described method(s), process(es), or technique(s) can be performed during each iteration, after a plurality of iterations, or at the end of all the iterations.

The above described method(s), process(es), or technique(s) could be implemented by a series of processor readable instructions stored on one or more non-transitory processor-readable media. Some examples of the above described method(s), process(es), or technique(s) method are performed in part by a specialized device such as an adiabatic quantum computer or a quantum annealer or a system to program or otherwise control operation of an adiabatic quantum computer or a quantum annealer, for instance a computer that includes at least one digital processor. The above described method(s), process(es), or technique(s) may include various acts, though those of skill in the art will appreciate that in alternative examples certain acts may be omitted and/or additional acts may be added. Those of skill in the art will appreciate that the illustrated order of the acts is shown for example purposes only and may change in alternative examples. Some of the example acts or operations of the above described method(s), process(es), or technique(s) are performed iteratively. Some acts of the above described method(s), process(es), or technique(s) can be performed during each iteration, after a plurality of iterations, or at the end of all the iterations.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to control systems for electric machines, not necessarily the exemplary systems, methods, and apparatus generally described above. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A dynamically reconfigurable power converter operable selectively as an open winding coil driver or as a poly phase system, comprising:
a voltage bus having a first voltage rail and a second voltage rail, the voltage bus coupled or couplable between a direct current (DC) storage and a power source;
a first set of switches wherein at least two pairs of switches of the first set of switches are arranged in respective half bridges between the first and the second voltage rails of the voltage bus, each of the half bridges having a respective a center node that is coupled or couplable to a first terminal of a respective coil of an electric machine;
a second set of switches wherein at least two pairs of switches of the second set of switches are arranged in respective half bridges between the first and the second voltage rails of the voltage bus, each of the half bridges having a respective a center node that is coupled or couplable to a second terminal of a respective coil of the electric machine;
a third set of switches wherein one or more switches of the third set of switches is electrically coupled in the first voltage rail and one or more switches of the third set of switches is electrically coupled in the second voltage rail, and the switches of the third set of switches are operable to selectively isolate the second set of switches; and
a fourth switch that is operable to electrically couple and electrically uncouple the power source to one of the first voltage rail or the second voltage rail.

2. The dynamically reconfigurable power converter according to claim 1, further comprising:
a control subsystem, the control subsystem communicatively coupled to control a state of the switches of the first set of switches, a state of the switches of the second set of switches, and a state of the switches of the third set of switches.

3. The dynamically reconfigurable power converter according to claim 2 wherein the control subsystem controls the state of the switches to operate the first set of switches as series half bridges, to operate the second set of switches as parallel half bridges, and to operate the third set of switches as series AC switches.

4. The dynamically reconfigurable power converter according to claim 2 wherein, in a dual open winding/parallel mode, the control subsystem controls the state of the switches to operate the first set of switches and the second set of switches as open winding inverters using a respective H bridge per coil, and to place all of the switches of the third set of switches in an ON state to electrically couple the first voltage rail and the second voltage rail of the voltage bus to the switches of the second set of switches.

5. The dynamically reconfigurable power converter according to claim 2 wherein, in a dual open winding/parallel mode, the control subsystem controls the state of the switches to operate the first set of switches and the second set of switches as H bridge inverters for respective coils of the electric machine, and to place all of the switches of the third set of switches in an ON state to electrically couple the first voltage rail and the second voltage rail of the voltage bus to the switches of the second set of switches.

6. The dynamically reconfigurable power converter according to claim 2 wherein, in a series mode, the control subsystem controls the state of the switches to operate the switches of the first set of switches as a single-phase H bridge inverter; to place all of the switches of the second set of in an ON state completing a series connection, and place all of the switches of the third set of switches in an OFF state to disconnect the voltage bus from the switches of the second set of switches allowing the series connection to float.

7. The dynamically reconfigurable power converter according to claim 2 wherein, when configured for an external power transfer via the fourth switch, the control subsystem controls the state of the switches to: in a first half cycle place one of the switches of the third set of switches in an ON state and operates the switches of the first set of switches and the switches of the second set of switches in one of an interleaved buck mode or a boost mode based on an input voltage, and in a second half cycle, place all of the switches of the first set of switches in an OFF state, place all of the switches of the second set of switches in an ON state, and place another one of the switches of the third set of switches in an ON state.

8. The dynamically reconfigurable power converter according to claim 2 wherein, when configured for an external power transfer, the control subsystem controls the state of the switches to: provide a negative connection to the voltage bus via one phase, and to concurrently provide either a step-up or a step-down DC-DC power conversion via another phase.

9. The dynamically reconfigurable power converter according to claim 2, wherein the electric machine comprises an AC motor and wherein the first set of switches is operative in a first mode as part of an inverter circuit under control of the controller subsystem, wherein in operation of the first mode, the inverter circuit converts DC power from the power storage into AC power applied to the at least one coil of the AC motor.

10. The dynamically reconfigurable power converter according to claim 2, wherein the electric machine is a poly phasic machine comprising a pair of windings for each phase, and wherein the second set of nodes is electrically connectable to each pair of windings of each phase, and wherein in operation of a second mode, the coils of each pair are energized in opposite polarities such that a net effect on mechanical movement of the electric machine is nullified.

11. The dynamically reconfigurable power converter according to claim 2, wherein in operation of a second mode, power is transferred such that the power source supplies power to charge the power storage.

12. The dynamically reconfigurable power converter according to claim 11, wherein the power source is an AC power grid, and wherein the first set of switches is operative, under control of the controller subsystem, to rectify AC power from the AC power grid to produce DC power.

13. The dynamically reconfigurable power converter according to claim 2, wherein in operation of a second mode, power is transferred such that the power storage supplies power to the power source.

14. The dynamically reconfigurable power converter according to claim 13, wherein the power source is an AC power grid, and wherein the first set of switches is operative, under control of the controller subsystem, to invert DC power from the power storage into AC power to be transferred to the AC power grid.

15. The dynamically reconfigurable power converter according to claim 2, wherein in operation of a second mode, the controller subsystem configures the switches, including the switches of the first set of switches, to implement a boost converter utilizing the at least one winding of the electric machine as a voltage-boosting inductor.

16. The dynamically reconfigurable power converter of claim 1 wherein there the electric machine includes a number N of coils and the dynamically reconfigurable power converter includes an equal number of H bridge inverters, one for each respective coil, with respective half bridge legs of the H bridge inverters on each side of the third set of switches.

17. (canceled)

18. The dynamically reconfigurable power converter according to claim 1, further comprising:
an energy storage capacitor electrically coupled across the first voltage rail and the second voltage rail of the voltage bus between the second set of switches and the third set of switches, wherein the energy storage capacitor averages out current for switches of the third set of switches.

19. (canceled)

20. A method of operating a dynamically reconfigurable power converter operable selectively as an open winding coil driver or as a poly phase system, wherein the dynamically reconfigurable power converter comprises: a voltage bus having a first voltage rail and a second voltage rail, the voltage bus coupled or couplable between a direct current (DC) storage and a power source; a first set of switches wherein at least two pairs of switches of the first set of switches are arranged in respective half bridges between the first and the second voltage rails of the voltage bus, each of the half bridges having a respective a center node that is coupled or couplable to a first terminal of a respective coil of an electric machine; a second set of switches wherein at least two pairs of switches of the second set of switches are arranged in respective half bridges between the first and the second voltage rails of the voltage bus, each of the half bridges having a respective a center node that is coupled or couplable to a second terminal of a respective coil of the electric machine; and a third set of switches wherein one or more switches of the third set of switches is electrically coupled in the first voltage rail and one or more switches of the third set of switches is electrically coupled in the second voltage rail, and the switches of the third set of switches are operable to selectively isolate the second set of switches, the method comprising:
determining an operating mode; and
in response to determining that the operating mode is a dual open winding/parallel mode, controlling, by a control subsystem, a state of a plurality of switches of a first set of switches and a state of a plurality of switches of a second set of switches as open winding inverters with a respective H bridge per coil, and placing all switches of a third set of switches in an ON state to electrically couple the first voltage rail and the second voltage rail of the voltage bus to the switches of the second set of switches.

21. The method according to claim 20, further comprising:
in response to determining that the operating mode is a series mode, controlling, by the control subsystem, the state of the switches to operate the switches of the first set of switches as a single-phase H bridge inverter; to place all of the switches of the second set of in an ON state completing a series connection, and place all of the switches of the third set of switches in an OFF state to disconnect the voltage bus from the switches of the second set of switches allowing the series connection to float.

22. The method according to claim 21, further comprising:
in response to determining that the operating mode is a motor mode:
determining a torque request;
verifying a coil configuration;
in response to determining that the coil configuration is not verified:
disabling an existing pulse width modulated drive signal;
changing the state of one or more of the switches to establish a new coil configuration; and
enabling a new existing pulse width modulated drive signal; and
providing motor current control via the switches.

23. (canceled)

24. The method according to claim 21, further comprising:
in response to determining that the operating mode is a charge mode:
determining whether a rotor of the electric machine is moving;
in response to determining that the rotor of the electric machine is not moving:
determining whether input power is alternating current (AC) or direct current (DC);
in response to determining that the input power is AC:
configuring the switches to rectify the AC; and
operating the switches to control a charging current supplied to the power storage.

25. The method according to claim 24 wherein, in response to determining that the input power is AC, further:
accessing a set of AC control parameters before configuring the switches to rectify the AC;
performing AC compensation; and
monitoring for an end of charging mode condition.

26. The method according to claim 21, further comprising:
in response to determining that the operating mode is a charge mode:
determining whether a rotor of the electric machine is moving;
in response to determining that the rotor of the electric machine is not moving:
determining whether input power is alternating current (AC) or direct current (DC);
in response to determining that the input power is DC:
configuring the switches to condition the DC; and
operating the switches to control a charging current supplied to the power storage.

27. (canceled)

28. (canceled)
